(19) United States
(12) Patent Application Publication
(10) Pub. No.: US 2025/0378247 A1
(43) Pub. Date: Dec. 11, 2025

(54) SYSTEM AND METHOD FOR IMPLEMENTATION OF COMPUTATIONAL LOGIC USING DIGITAL VLSI SYSTEMS

(71) Applicant: Uma Pandey, Hamirpur (IN)

(72) Inventors: Kumar Sambhav Pandey, Hamirpur (IN); Hitesh SHRIMALI, Mandi (IN)

(21) Appl. No.: 18/878,666

(22) PCT Filed: May 25, 2023
(86) PCT No.: PCT/IN2023/050496

§ 371 Date: Dec. 24, 2024

(30) Foreign Application Priority Data
May 25, 2022 (IN) 202211030038

(51) Int. Cl. G06F 30/327; H03K 19/20

(52) U.S. Cl. CPC G06F 30/327; H03K 19/20

(57) ABSTRACT

Subscalar digital arithmetic computing paradigm is disclosed. The atomic data and atomic operations thereon are broken down into sub-atomic data fragments and sub-atomic partial operations. Such a break-up exposes hitherto unexploited levels of parallelism by way of allowing overlap of operations even if data-dependent. It is found that this improved exploitation of latent parallelism to enhance processing throughputs comes with a favourable impact on the area-power characteristics of corresponding computing structures. The present invention may be implemented through synthesized circuits and may result in an enhanced improvement in their area-throughput figure-of-merit (FOM).

### CROSS-REFERENCE INFORMATION

This application is a national phase of Indian PCT Application No. PCT/IN2023/050496 titled “SYSTEM AND METHOD FOR IMPLEMENTATION OF COMPUTATIONAL LOGIC USING DIGITAL VLSI SYSTEMS” which claims priority to the Indian provisional patent application No. 20/221,1030038, filed May 25, 2022, entitled “IMPLEMENTATION OF DIGITAL INTEGRATED CIRCUITS ORGANIZED AS SUBSCALAR ARCHITECTURES COMPOSED OF MICRO-CELL LIBRARY BLOCKS” both of which are hereby incorporated by reference in its entirety.

### TECHNICAL FIELD

The instant disclosure relates to a method and system for implementing computational logic in very large scale integrated (VLSI) system.

### BACKGROUND

Computing structures such as microprocessors designed using VLSI systems are used in personal computers, graphic cards, digital cameras, smart devices, etc. These computing structures implement computational logic which are generally synthesized in VLSI comprised of a number of logic gates. The processing throughput of these structures depends greatly on the organization of the computational logic being used. Further, parallelism and pipelining are the two key mechanisms for enhancing the processing throughput. It is known in the art that the presence of data-flow dependencies adversely impacts the exploitation of such parallelism. The performance of digital systems cannot be arbitrarily enhanced merely by way of exploiting parallelism at data-word boundaries in presence of such data-flow dependencies. A deeper inspection and research on the architectures of arithmetic computing structures, reveal that neither all the bits of the result are produced simultaneously nor do all the bits of operands are consumed simultaneously in any logical operation. Further, some implementations in prior art, operate on operands with less precision in order to be faster and to consume less silicon resources. However, such architectures compromise on data width in one way or the other.

Therefore, there is a requirement to develop a computational methodology utilizing parallelism in a manner that is resource friendly and allows processing with higher efficiency and speed.

### SUMMARY

In an embodiment, a method of implementing computational logic in digital Very Large-Scale Integration (VLSI) systems is disclosed. In one example, the method comprises receiving at least two inputs as atomic data of a pre-defined bit size. The method further comprises of splitting these atomic data into a plurality of sub-atomic data fragments based on a pre-defined valency. The method further comprises splitting each of a plurality of atomic operations into a plurality of sub-atomic operations. In an embodiment, the splitting of each of the plurality of atomic operations may be based on the complexity of the plurality of atomic operations. The method further comprises performing at least one sub-atomic operation on at least two sub-atomic data fragments from the plurality of sub-atomic data fragments to generate at least one sub-atomic output data fragment. In an embodiment, the at least one sub-atomic operation may be performed by processing the at least two sub-atomic data fragments to produce the at least one sub-atomic output data fragment in different clock cycles and in a timemultiplexed manner for individual data fragments of any atomic operand datum.

In another embodiment, a system for implementing computational logic in digital VLSI systems is disclosed. In one example, the system comprises one or more logic circuitry which may be configured to receive at least two inputs as atomic data, wherein the atomic data is of a pre-defined bit size. The logic circuitry may be further configured to split the atomic data into a plurality of sub-atomic data fragments based on a predefined valency. The logic circuitry may be further configured to split each of a plurality of atomic operations into a plurality of sub-atomic operations. In an embodiment, the plurality of atomic operations may be split based on complexity of the plurality of atomic operations. The logic circuitry may be further configured to perform at least one subatomic operation on at least two sub-atomic data fragments from the plurality of subatomic data fragments to generate at least one sub-atomic output data. In an embodiment, the at least one sub-atomic operation may be performed by processing the at least two sub-atomic data fragments to produce the at least one sub-atomic output data fragment in different clock cycles and in a time-multiplexed manner for individual data fragments of any atomic operand datum.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, explain the disclosed principles.

FIG. 1A illustrates an exemplary computation with two state-of-the-art parallel prefix adders connected in cascade, in accordance with some embodiments.

FIG. 1B illustrates an exemplary implementation of block gpt using NAND gates, in accordance with an exemplary embodiment.

FIG. 1C illustrates an exemplary implementation of block reduce using NAND gates, in accordance with an exemplary embodiment.

FIG. 1D illustrates an exemplary implementation of block carry using NAND gates, in accordance with an exemplary embodiment.

FIG. 1E illustrates an exemplary implementation of block sum using NAND gates, in accordance with an exemplary embodiment.

FIG. 2A illustrates an exemplary implementation using two arrays of partial adders according to subscalar implementation connected in cascade, in accordance with an embodiment of the present disclosure.

FIG. 2B illustrates an exemplary implementation of partial adder using NAND gates, in accordance with an embodiment of the present disclosure.

FIG. 3A illustrates a Gantt chart of computation of three atomic operations in an unpipelined manner, in accordance with an exemplary embodiment.

FIG. 3B illustrates an architectural diagram of computation with feedback paths of atomic operations in an unpipelined manner, in accordance with an exemplary embodiment.

FIG. 4A, illustrates a Gantt chart of computation of three atomic operations in a pipelined manner, in accordance with an exemplary embodiment.

FIG. 4B and FIG. 4C illustrate architectural diagrams of computation with feedback paths of atomic operations in a pipelined manner with balanced and unbalanced pipeline stages, in accordance with an exemplary embodiment.

FIG. 5A illustrates a Gantt chart of computation of three atomic operations in an unpipelined manner using data fragmentation, in accordance with an exemplary embodiment.

FIG. 5B illustrates an architectural diagram of computation with feedback paths of atomic operations in an unpipelined manner using data fragmentation, in accordance with an exemplary embodiment.

FIG. 6A illustrates an unpipelined subscalar methodology of computation of one or more atomic operations with respect to time is illustrated, in accordance with an embodiment of the present disclosure.

FIG. 6B, illustrates a pipelined subscalar methodology of computation of one or more sub-atomic operations with respect to time, in accordance with an embodiment of the present disclosure.

FIG. 6C illustrates an architectural diagram of computation with feedback paths of atomic operations using subscalar methodology, in accordance with an embodiment of the present disclosure.

FIG. 9A, FIG. 9B and FIG. 9C illustrates area-throughput figure-of-merit (FOM) for the unpipelined, pipelined, and subscalar implementations at pair, nibble, and byte valencies of the chosen benchmark circuits are plotted as histograms for an 8-bit, 16bit, 32-bit data-path widths, in accordance with an experimental embodiment of the present disclosure.

### DETAILED DESCRIPTION

The present invention presents a case for a new computing paradigm namely subscalar digital arithmetic which is aimed at mitigating the issue of parallel computing in presence of data-flow dependencies.

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The instant disclosure proposes to breaking up of atomic data and atomic operations thereon into sub-atomic data fragments and sub-atomic partial operations respectively. Such a break-up exposes hitherto unexploited levels of parallelism by way of allowing overlapping of operations even if they are data dependent. Applicants have found that the improved exploitation of latent parallelism to enhance processing throughputs comes with a favourable impact on the area-power characteristics of corresponding computing structures.

An exemplary computational logic may be represented by the equation:

$$s = a + b + c \qquad ( 1 )$$

The computation of s involves computation of an intermediate sum a+b, the result of which can be added to c to get the value of s. In an exemplary implementation, it may be assumed that a, b, c, and s are all 4-bit unsigned integers. In an embodiment, the implementation architecture of said computation logic may involve a cascade connection of two standard 4-bit adders.

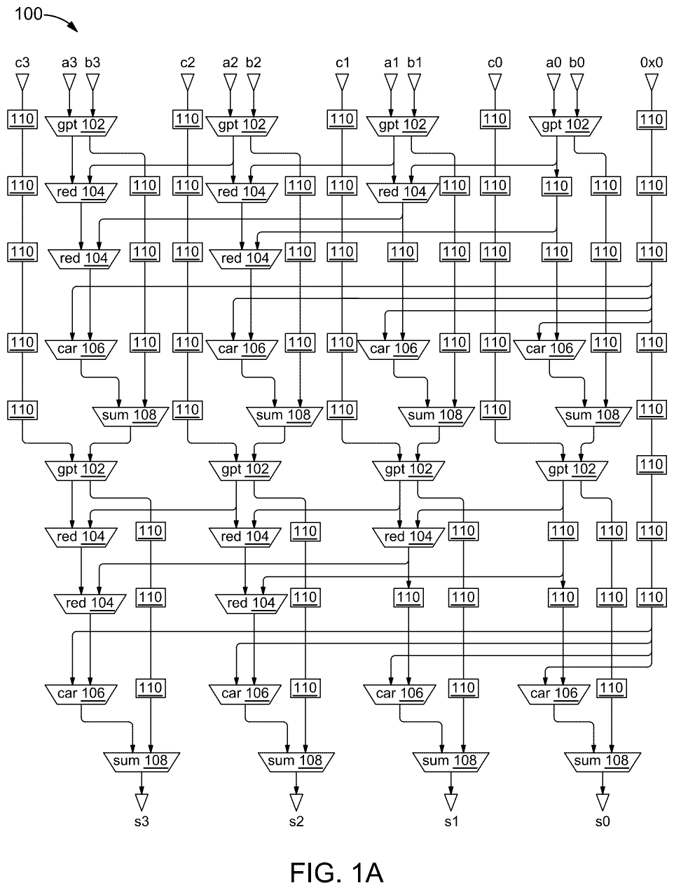

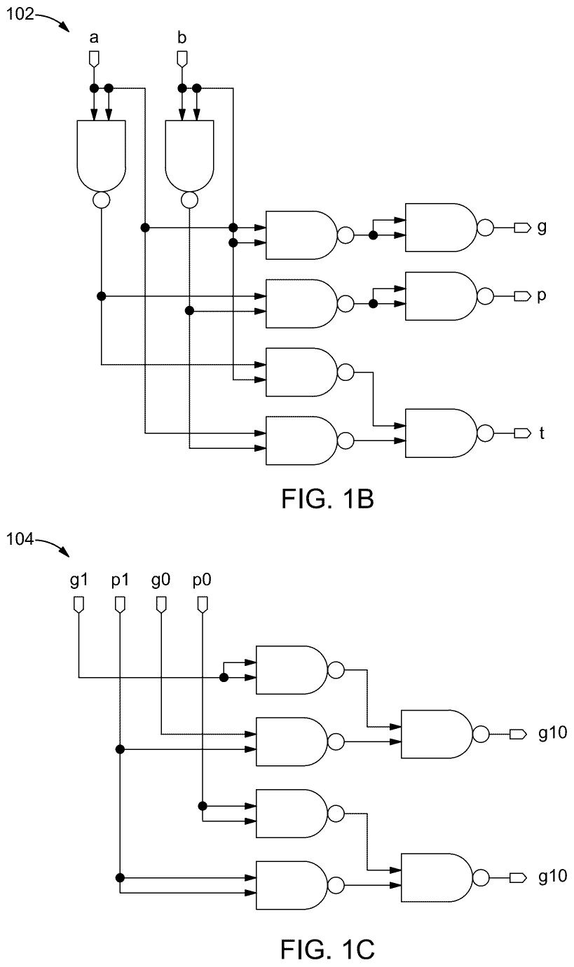

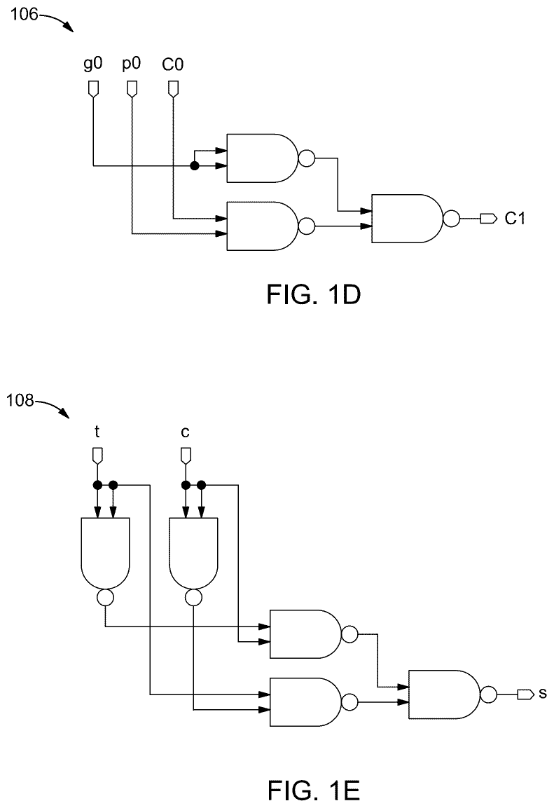

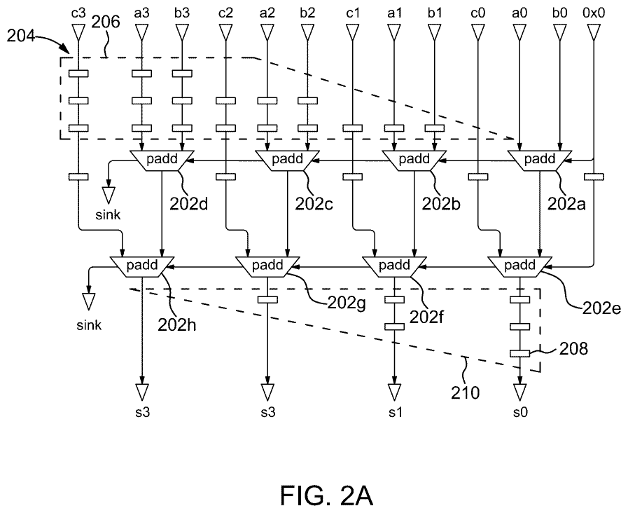

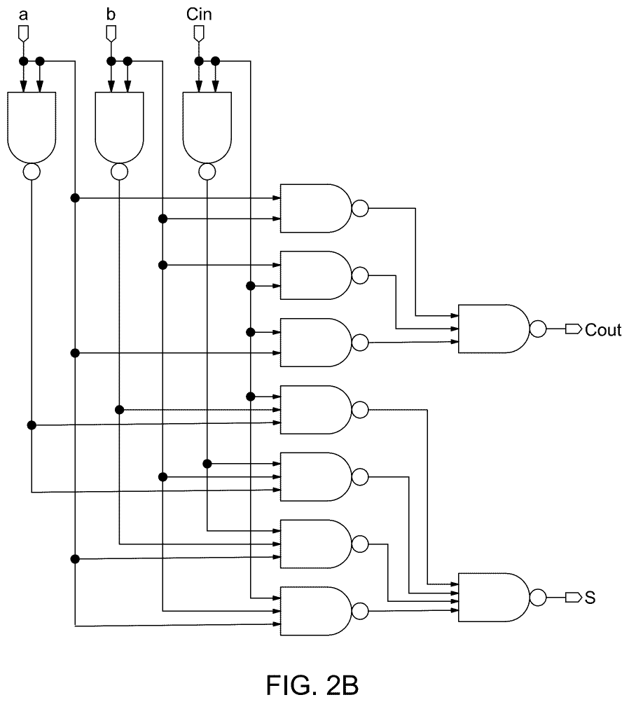

In reference to an exemplary computation as shown in FIG. 1A, where state-ofthe-art parallel prefix adders having 1-bit valency, may be seen to be deployed. The conventional semantics of blocks Generate, Propagate and Transmit (gpt) 102, Reduce (red) 104, Carry (car) 106 and Sum 108 have been implemented. The block ‘gpt’ computes three signals namely generate (gᵢ), propagate (pᵢ), and transmit (tᵢ) locally at individual bit positions ‘i’. For 1-bit valency, the three signals may be defined as per equations (2, 3 and 4).

$${g}_{i} = {a}_{i} \cdot {b}_{i} \qquad ( 2 )$$

$${p}_{i} = {a}_{i} + {b}_{i} \qquad ( 3 )$$

$${t}_{i} = {a}_{i} ⊕ \cdot {b}_{i} \qquad ( 4 )$$

FIG. 1B illustrates an exemplary implementation of block gpt 102 using NAND gates, in accordance with an exemplary embodiment.

FIG. 1C illustrates an exemplary implementation of block reduce 104 using NAND gates, in accordance with an exemplary embodiment.

FIG. 1D illustrates an exemplary implementation of block carry 106 using NAND gates, in accordance with an exemplary embodiment.

FIG. 1E illustrates an exemplary implementation of block sum 108 using NAND gates, in accordance with an exemplary embodiment. Table 1 below provides, a number of NAND gates needed to implement the gpt logic block 102, the reduce logic block 104, the carry logic block 106 and the sum logic block 108, implemented in the exemplary implementation as shown in FIG. 1B, FIG. 1C, FIG. 1D, FIG. 1E.

TABLE 1

| | No. of NAND | No. of Logic |
|---|---|---|
| Logic Block | gates | Level |
| Gpt | 9 | 3 |
| Reduce | 6 | 2 |
| carry | 3 | 2 |
| sum | 5 | 3 |

Accordingly, Table 1 depicts a number of NAND gates required along with a number of logic levels of the gpt logic block 102, the reduce logic block 104, the carry logic block 106 and the sum logic block 108. Accordingly, it may be seen that for performing one iteration of equation (1) using the gpt logic block 102, the reduce logic block 104, the carry logic block 106 and the sum logic block 108 at same frequency as the slowest stage as per the implementation shown in FIG. 1B, FIG. 1C, FIG. 1D, FIG. 1E, a total of 34 logic blocks and 59 1-bit registers are required 110 and may have a 10cycle latency with 1 operation being performed per cycle.

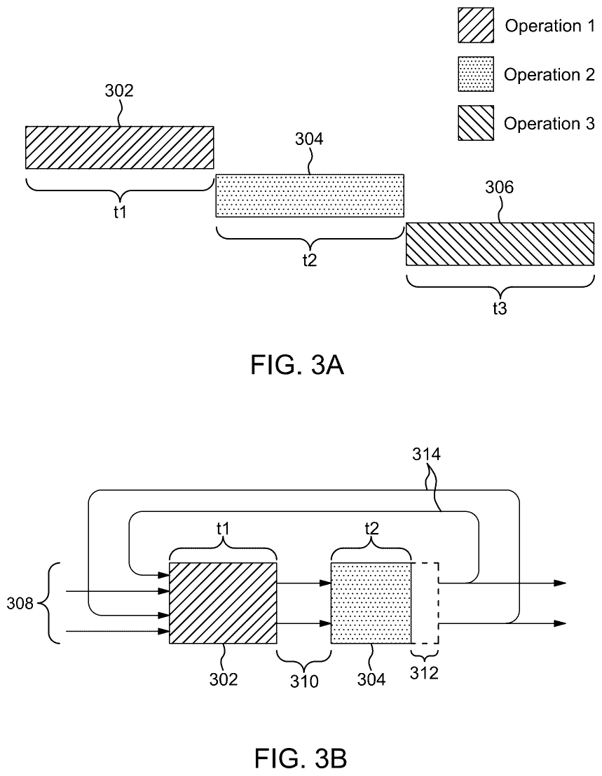

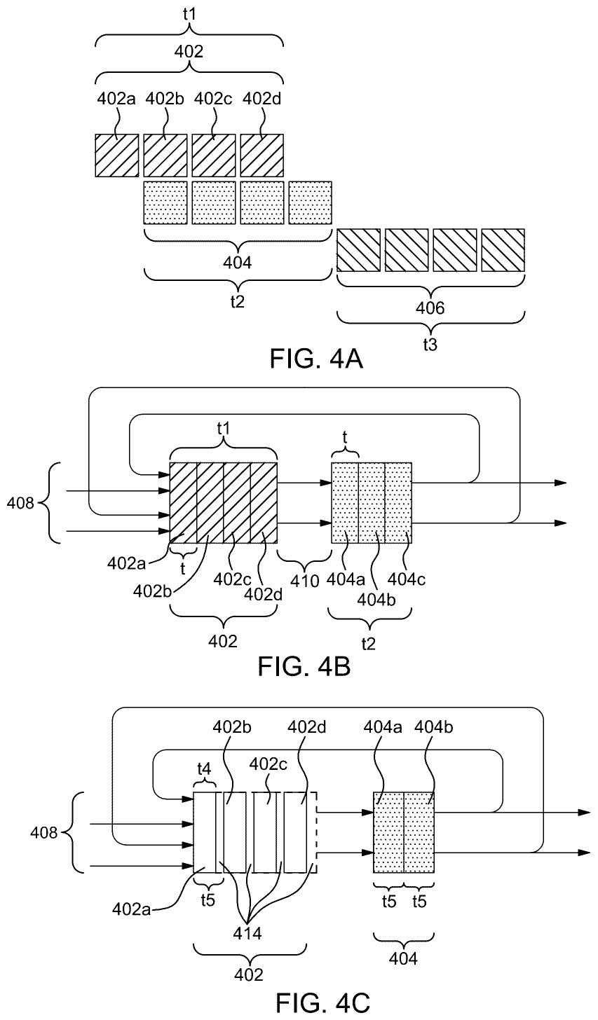

FIG. 2A illustrates an exemplary implementation using partial adders according to subscalar computing implementation, in accordance with an embodiment of the present disclosure.

As an exemplary embodiment for implementing equation (1) according to subscalar computing implementation, partial adder logic blocks 202a-h as indicated by padd and collectively referred to as partial adder logic block 202, may be used along with 1-bit pipeline registers 204 and 210 as shown in FIG. 2A.

In an embodiment, a plurality of registers 204 may be utilized in an input preprocessing block 206 which may differentially delay the inputs to padd 202b-d in order to schedule input data fragments in sequence of happening of subatomic operations.

In an embodiment, a plurality of registers 208 may be utilized in an output postprocessing block 210 which may differentially delay the outputs of the padd 202e-h in reverse order to schedule output data fragments such that output of the entire atomic operation is received as a scalar data simultaneously.

FIG. 2B illustrates an exemplary implementation of partial adder using NAND gates, in accordance with an embodiment of the present disclosure. Accordingly, a total of 12 NAND gates are being utilized in 3 logic levels. The resulting Subscalar implementation performs the computation of equation (1) using partial adder logic padd 202 by utilizing 48 NAND gates and 39 1-bit registers as shown in FIG. 2A. Accordingly, the implementation as depicted in FIG. 2B consumes much less silicon resource in contrast to the implementation shown in FIG. 1A which utilizes 166 NAND gates and 118 1-bit registers.

Table 2 below depicts area-latency characterization of the implementation depicted in FIG. 1A and FIG. 2A. In an embodiment, the area-latency characterization of the implementation depicted in FIG. 1A and FIG. 2A may be estimated with opensource digital application specific integrated circuit (ASIC) implementation flow open lane using sky130_fd_sc_hd standard cell library.

TABLE 2

| | | Latency |
|---|---|---|
| Block | Area μm²) | (n sec) |
| Gpt | 2180 | 60 |
| Red | 2950 | 40 |
| Car | 1690 | 60 |
| Sum | 560 | 10 |
| padd | 3170 | 60 |

As may be observed both the designs may run at the same frequency (60 n sec) to accommodate the slowest stage. The computation shown in FIG. 1A, however, may take 10 cycles, but the computation shown in FIG. 2A may take only 5 cycles to complete one iteration of equation (1), thus the throughput of the implementation of FIG. 1A may be slower by a factor of two when compared with the throughput of the implementation of FIG. 2A. The area estimates are 0.06494 mm² and 0.02536 mm² respectively, which may also get better by a factor of almost two and a half when implemented using subscalar computing methodology.

Accordingly, the implementation of computational logic using subscalar methodology may preserve the data width and by processing smaller fragments of fullwidth data gainfully to reduce the complexities either in space, or time, or both.

In an exemplary embodiment, computational methodologies have been described based on utilization of one instance of a unit for implementation of the atomic operations f.

The subscalar computational logic implements an overlapped execution of data dependent or independent plurality of atomic operations. A subscalar computing unit (not shown) may perform various atomic operations which may be based on one or more logical computational logics such as addition, subtraction, multiplication, shift, mux, de-mux, etc. implemented to output a resultant data.

In an exemplary embodiment, the atomic operations f which may be denoted using exemplary equations (5), (6) and (7) respectively as given below. In an embodiment, the function f may include but not limited to add, subtract, multiply, etc. having a bit-wise carry/borrow propagation and may be a function f not having bit-wise carry/borrow propagation. In an embodiment, the function f may also include a feedback from the output to the input. In an exemplary embodiment, the first two operations of equation (5) and equation (6) may be mutually exclusive or in other words data independent of each other while, the operation of equation (7) may be data dependent on operation of equation (6). The data output of operation of equation (6) is an input operand for operation of equation (7) as shown in equations below:

$$x = f ( a , b ) \qquad ( 5 )$$

$$y = f ( c , d ) \qquad ( 6 )$$

$$z = f ( y , e ) \qquad ( 7 )$$

In an embodiment, the operations of the equations (5), (6) and (7) may be referred to herein after as atomic operations which may operate on input atomic data as operands and may generate atomic output data x, y, and z. In an embodiment, the atomic output data x, y, and z may be generated using a single instance of logical circuitry of a function f for performing one or more logical computation on the input atomic data. In an embodiment, the input atomic data may be unsigned 32-bit integers and in order to compute x, y and z only a single instance of logic circuitry to implement function f is available.

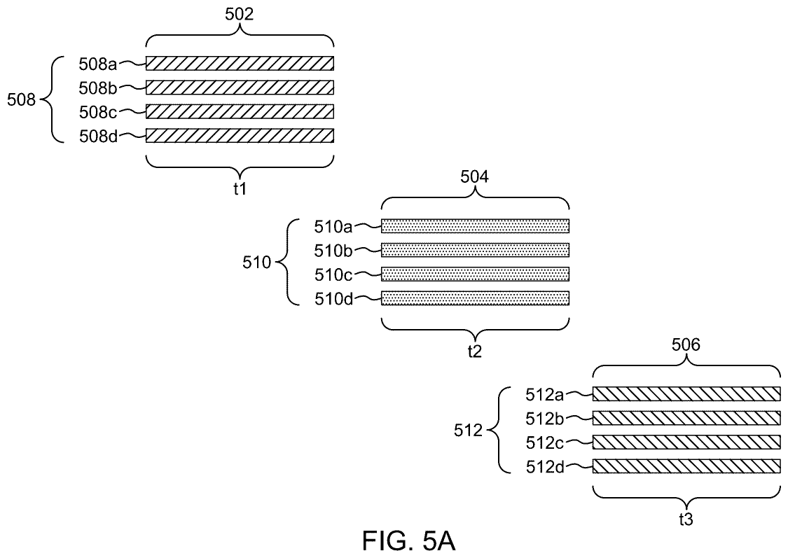

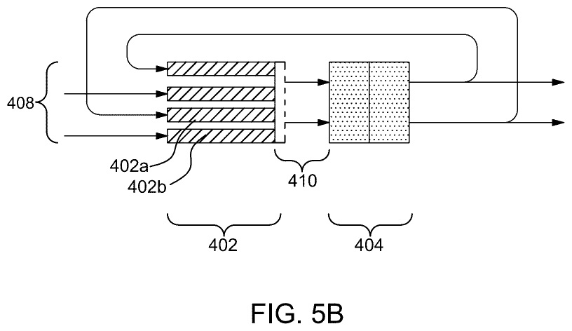

FIG. 3A and FIG. 3B illustrate a Gantt chart diagram and a structure diagram respectively of computation of atomic operations in an unpipelined manner, in accordance with an exemplary embodiment.

Referring to FIG. 3A, a Gantt chart for an unpipelined implementation of computation progress of the equations (5), (6) and (7) with respect to time t is depicted as 302, 304 and 306 respectively. In an embodiment, the atomic operation 302 may be performed in time t₁, the atomic operation 304 may be performed in time t₂ and atomic operation 306 may be performed in time t₃. Referring to FIG. 3B, an unpipelined structural implementation for computation of the atomic operations 302 and 304 with respect to input atomic datum as operand 308 is illustrated. In an unpipelined implementation using a single instance of the implementation unit, the atomic operations 302-306 may be computed in a serialized or cascaded manner in order to be computed one after another. As discussed above in FIG. 3A, the atomic operation 302 may be performed in time t₁, the atomic operation 304 may be performed in time t₂ and atomic operation 306 may be performed in time t₃. Further, the computation of each atomic operation 302-306 when operating on their corresponding atomic input operand 308, 310 and 312 respectively may be performed in time synchronized manner as per a fixed clock cycle irrespective of the complexity of the operations. In an exemplary embodiment, as depicted in FIG. 3B the atomic operation 302 may be more complex and may take time t₁ for completion. The atomic operation 304 may be less complex than the atomic operation 302 and may require lesser time than t₂ for its completion. Therefore, there may be a delay 312 after the computation of the atomic operation 304 as the clock cycle is fixed as the clock cycle is greater than the time t₂. Accordingly, the clock cycle in a pipelined operation may be equivalent to the time of computation of the most complex atomic operations which are to be computed. Accordingly, the time delay 312 may be attributed as an unutilized or waste time. In an embodiment, in case of combinational circuits, the atomic operations 302-306 may be computed in a time independent manner. Thus, the atomic output of any of the operations 302-306 may not depend on any of their previous inputs. However, in case of sequential circuits, the atomic operations 302-306 may be computed in synchronization with a clock and may include a feedback path 314 between the output of the atomic operation 304 and the input of the atomic operation 302. Accordingly, in case of sequential circuits the input atomic datum 310 may be dependent on the atomic output of atomic operation 302.

In an embodiment, the feedback path 314 from the output of the one or more atomic operations may be required to be implemented in order continue an iterative computation of the one or more atomic operations 302-306. Accordingly, as shown in FIG. 3B, a successive iteration may only be initiated after an interval of 8 clock cycles.

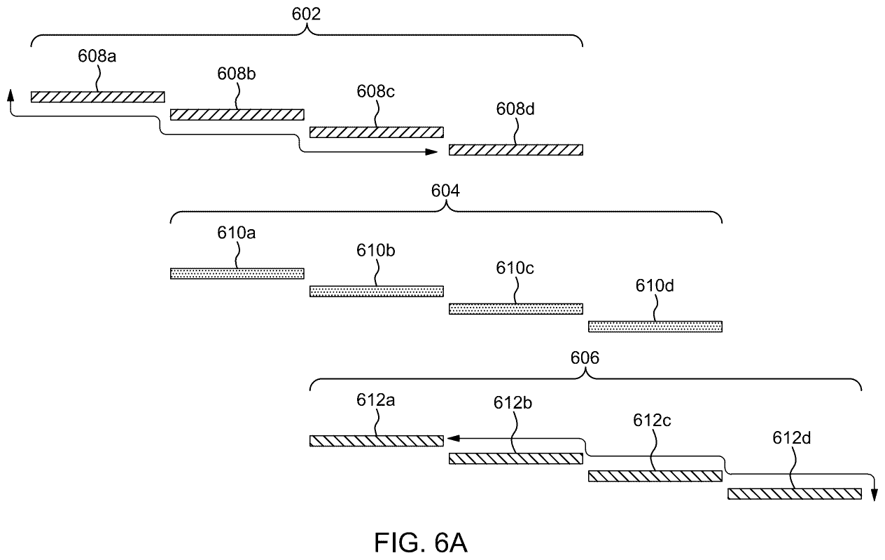

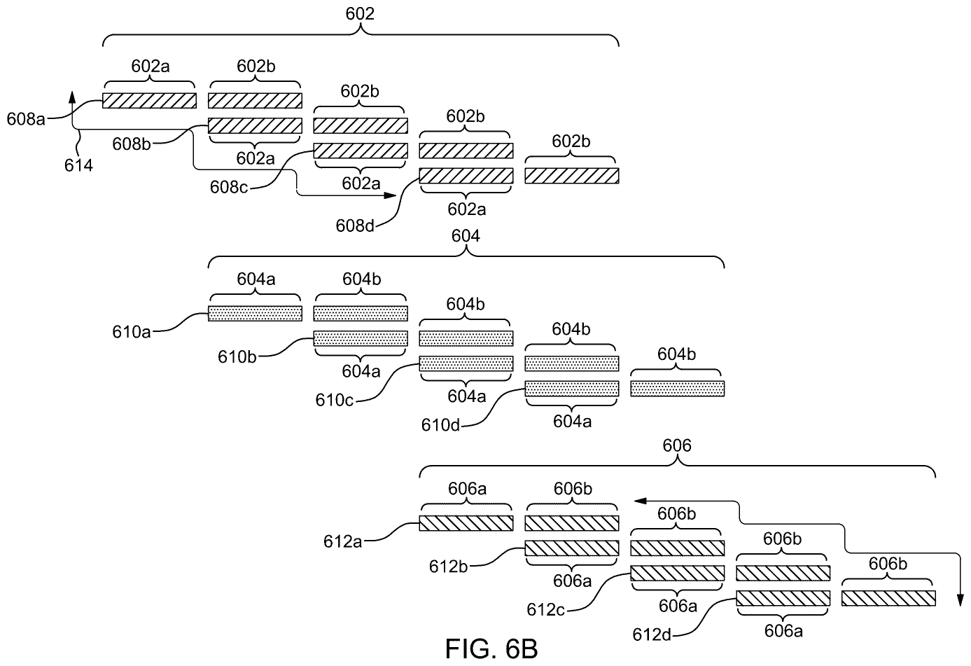

FIG. 4A, FIG. 4B and FIG. 4C illustrate a Gantt chart diagram and a structure diagram respectively of computation of atomic operations in a pipelined manner with balanced and unbalance clock cycle respectively, in accordance with an exemplary embodiment.

Referring now to FIG. 4A, a Gantt chart of a pipelined implementation of computation of the atomic operations 402-406 with respect to time is depicted. Referring to FIG. 4B, a pipelined structural implementation for computation of atomic operations 402 and 404 respectively with respect to input atomic datum as input operands 408 and 410 respectively. In a pipelined implementation, using a single instance of the implementation unit, the atomic operations 402-406 may be computed by splitting each of the atomic operations 402-406 into one or more sub-atomic operations 402a-d, 404ad and 406a-d respectively. In an embodiment, an atomic operation may be split into subatomic operations based on a complexity level of the atomic operation and time required to perform each of the subatomic atomic operations. Accordingly, in an exemplary embodiment, as depicted in FIG. 4A, the atomic operation 402 may be split into four subatomic operations 402a-d which may be computed in time t₁ and the atomic operation 404 may be split into subatomic operations 404a-d which may be computed in time t₂ respectively and implemented in a pipelined manner. Further, the computation of each atomic operation 402-406 when operating on their corresponding atomic input operand 408, 410 and 412 respectively may be performed in accordance with a clock cycle t which may be based on a total time required to complete the most complex subatomic operation of the atomic operations 402-406. FIG. 4B depicts a pipelined structure in which the sub-atomic operations 402a-d and 404a-c are performed in a balanced clock cycle such that the subatomic operations 402a-d and 404a-c of each atomic operations 402 and 404 are completed without any waste of clock time. FIG. 4C on the other hand depicts a pipelined structure in which the sub-atomic operations 402a-d and 404a-b are performed in balanced clock cycle such that each of the subatomic operations 402a-d of the atomic operations 402 are completed in time t₄ with a time delay of 414 each and the subatomic operations 404a-b are completed without any time delay in time t₅ each. In an explanatory scenario, the time delay 414 may be required as the subatomic operations 404a-b may be more complex and require more time for completion wherein the complexity of the subatomic operations 402a-d may be less than the subatomic operations of 404a-b. Accordingly, the clock cycle t may be equal to t₅.

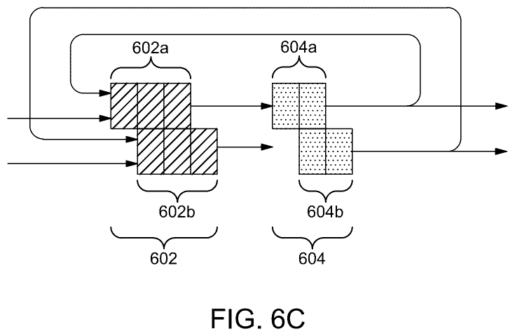

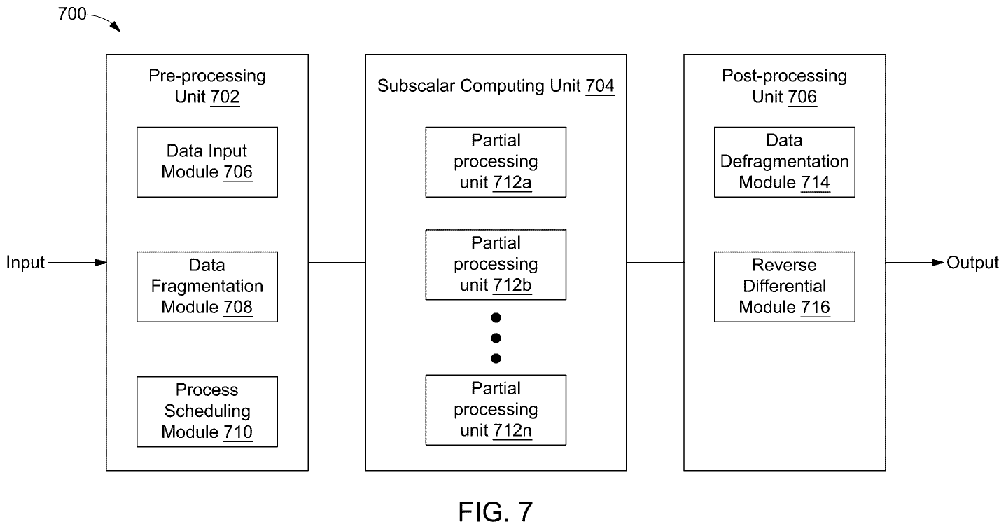

FIG. 5A illustrates a Gantt chart diagram of computation of atomic operations 502-506 in an unpipelined manner using data fragmentation of input datum, in accordance with an exemplary embodiment. Referring now to FIG. 5A, a Gantt chart diagram of an unpipelined implementation of atomic operations 502-506 respectively using data fragmentation of input operands. In an embodiment, the atomic operations 502-506 of the equations (5), (6) and (7) respectively may operate on input operands comprising inputs as atomic datum 508, 510 and 512 respectively. For example, the atomic datum 508, 510 and 512 may be of size, but not limited to, 32 bit, 64 bit, and so on. The atomic datum 508, 510 and 512 of each of the atomic operations 502-506 may be split into two or more sub-word or sub-atomic data fragments 508a-d, 510a-d and 512a-d respectively. In an exemplary scenario, a 32-bit input as atomic datum may be split into, but not limited to, four 8-bit sub-word or subatomic data fragments. However, since the computation of the atomic operations 502-508 are computed using an unpipelined unit, the computation of the atomic operation 502 is followed by computation of the atomic operations 504 and 506 operating on the subatomic data fragments 508ad, 510a-d and 512a-d respectively each consuming a computation time of t₁, t₂ and t₃ respectively.

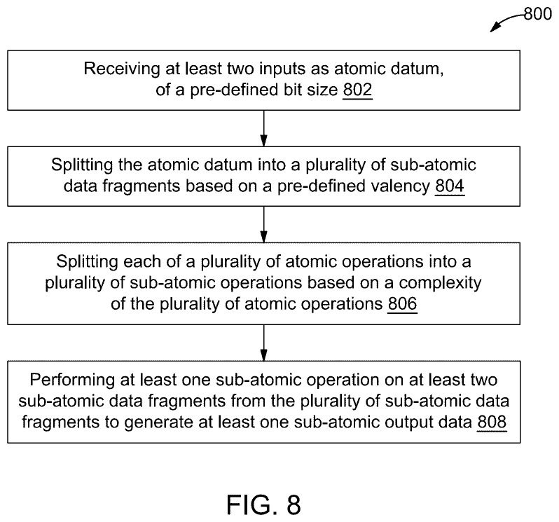

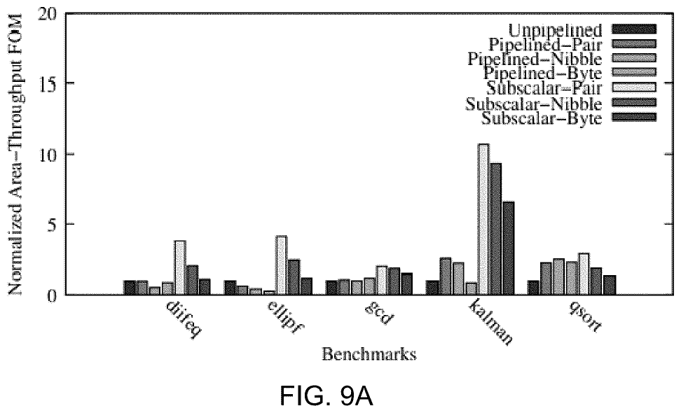

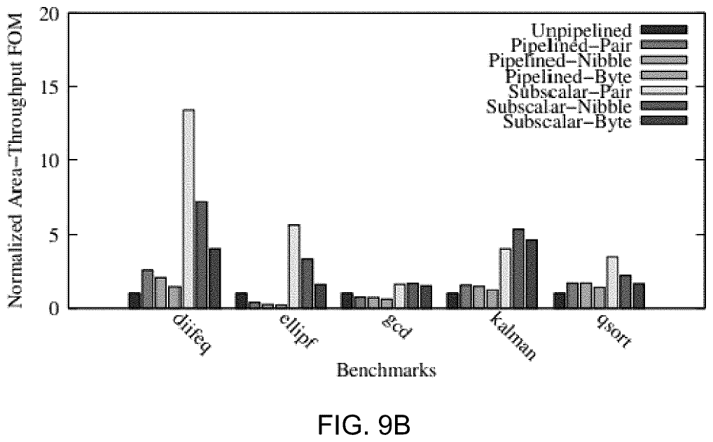

Referring now to FIG. 6A, a Gantt chart of computation progress of atomic operations using subscalar computing methodology in an unpipelined manner is illustrated, in accordance with an embodiment of the present disclosure.

In an embodiment, the subscalar computing methodology is based on an overlapped execution of data independent or data-dependent atomic operations as disclosed below. An unpipelined implementation of computation of the atomic operations 602, 604 and 606 in accordance with subscalar computing methodology.

In an unpipelined manner, the atomic operations 602, 604 and 606 may operate on atomic operands 608, 610 and 612 respectively in accordance with subscalar computing methodology. In an embodiment, the atomic datum of input operands 608, 610 and 612 may be split into sub-atomic data fragments 608a-d, 610a-d and 612a-d respectively. In an embodiment, each of the atomic operations 602, 604 and 606 may operate on the corresponding subatomic data fragments 608a-d, 610a-d and 612a-d respectively in an unpipelined manner. Accordingly, the subatomic operations of 602 may be performed to operate on the subatomic data fragment 608a in a first time instance. The partial sub-atomic output generated as result of the subatomic operation 602 on the subatomic data fragment 608a may be utilized as an input in the next subsequent computations of subatomic data fragment 608b. In the subsequent second time instance, the atomic operations of 602 and 604 may be performed simultaneously to operate on the subatomic data fragment 608b and the subatomic data fragment 610a. The partial sub-atomic output generated as result of the subatomic operations 602 and 604 on the subatomic data fragments 608b and 610a may be utilized as an input in the next subsequent computations of subatomic data fragments 608c and 610b. In the subsequent third time instance, the atomic operations of 602, 604 and 606 may be performed to operate simultaneously on the subatomic data fragment 608c, the subatomic data fragment 610b and the subatomic data fragment 612a respectively. The partial sub-atomic output generated as result of the subatomic operations 602 and 604 on the subatomic data fragments 608c and 610b and may be utilized as an input in the next subsequent computations of subatomic data fragment in next time instant. The data dependency of the atomic operation 606 is compensated as the computation of the atomic operation of 606 may be based on an output data of the atomic operation of 604 which has already outputted an output data fragment in the second time instance which acts as an input data fragment 612a for the atomic operation of the atomic operation 606. Accordingly, the computation of the atomic operations 602, 604 and 606 respectively are performed in lesser time cycles and a step wave may be generated as depicted by 614. Thus, the computation of the atomic operations 602-606 may be performed in a time multiplexed manner.

FIG. 6B, illustrates a Gantt chart of a computation progress of atomic operations using subscalar computing methodology on a pipelined manner, in accordance with an embodiment of the present disclosure.

Referring now to FIG. 6B, a pipelined implementation of computation progress of the atomic operations 602, 604 and 606 respectively in accordance with subscalar methodology are depicted. The atomic operations 602, 604 and 606 may be split into a plurality of sub-atomic operations as depicted by 602a-b, 604a-b and 606a-b respectively. Wherein the subatomic operations 602a-b, 604a-b and 606a-b are implemented using pipelined unit and thus are computed in a time multiplexed manner. Further, the sub-atomic operations 602a-b, 604a-b and 606a-b may operate on atomic datum as input operands 608, 610 and 612 respectively. In an embodiment, the atomic datum 608, 610 and 612 may be split into subatomic data fragments 608a-d, 610a-d and 612a-d respectively. In an embodiment, each of the sub-atomic operations 602a-b, 604a-b and 606a-b may operate on the corresponding subatomic data fragments 608ad, 610a-d and 612a-d respectively in a pipelined manner. Accordingly, the subatomic operation of 602a may be performed to operate on the subatomic data fragment 608a in a first time instance. The partial sub-atomic output generated as result of the previous subatomic operation may be utilized in the subsequent computation of the subatomic operations in next clock cycle or time instant. In the subsequent second time instance, simultaneously the subatomic operation of 602b may be performed to operate on the subatomic data fragment 608a and the subatomic operation of 602a may be performed to operate on the subatomic data fragment 608b and subatomic operation of 604a may be performed to operate on the subatomic data fragment 610a. In the subsequent third time instance, the subatomic operation of 602b may be performed to operate on the subatomic data fragment 608b, simultaneously with the subatomic operation of 602a to operate on the subatomic data fragment 608c and the subatomic operation of 604b may be performed to operate on the subatomic data fragment 610a and the subatomic operation of 604a may be performed to operate on the subatomic data fragment 610b. Due to the input data dependency of the atomic operation 606 on the output data of the atomic operation 604, in the fourth time instance, the subatomic operation of 602b may be performed to operate on the subatomic data fragment 608c, simultaneously with the subatomic operation of 602a to operate on the subatomic data fragment 608d and the subatomic operation of 604b may be performed to operate on the subatomic data fragment 610b and the subatomic operation of 604a may be performed to operate on the subatomic data fragment 610c and the subatomic operation of 606a may be performed to operate on the subatomic data fragment 612a. Thus, as evident in the FIGS. 5A and 5B, the atomic operation 506 which is data dependent on the atomic operations 504 cannot be initiated before the computation of the atomic operation 504. Using subscalar methodology of computation as depicted in FIGS. 6A and 6B the computation of the atomic operation 606 which is data dependent on the output of the atomic operation 604 can be initiated without any delay.

FIG. 6C illustrates a structural diagram of computation of atomic operations using subscalar computing methodology, in accordance with an embodiment of the present disclosure. Referring to FIG. 6C, a pipelined structural implementation of an exemplary a sequential circuit for computation of atomic operations 602 and 604 in the forward path on atomic data as input operands 608 and 610 respectively a feedback path from the output operand to one of the input operands is shown. The atomic operations 602 and 604 may be split into a plurality of sub-atomic operations 602a-b and 604a-b. Further, the atomic operations 602 and 604 may operate on atomic input data operands 608 and 610 respectively. The atomic input data operands 608 and 610 may be split into subatomic data fragments. In an embodiment, the size of the subatomic data fragment may be equal to 1 bit, 2 bit, 4 bit, 8 bit, 16 bit, 32 bit, and so on. As shown in FIG. 6C the subatomic operations may be performed in five cycles.

In an embodiment, input atomic operands may be, but not limited to, integers, floating point numbers, etc. In an embodiment, the input atomic operands when computed using any atomic operation generates an output atomic operand of same size or valency as the input atomic operands. In an embodiment, the atomic operations 602ab and 604a-b are performed in a locked step manner such that the output subatomic data fragment generated as a result of the computation be a subatomic operation is fed as an input subatomic data fragment to the subsequent subatomic operation pipelined using subscalar methodology. The throughput achieved in the computation methodology illustrated in FIG. 6A, FIG. 6B and FIG. 6C is five time units per iteration which is comparatively lesser than the throughput achieved using conventional computation methodology illustrated in FIG. 3A, FIG. 3B, FIG. 4A, FIG. 4B and FIG. 4C which have throughput of up to nine time units per iteration.

FIG. 7 illustrates a functional block of a subscalar computing system implementing subscalar computational logic, in accordance with an embodiment of the present disclosure. The subscalar computing system 700 comprises of a pre-processing unit 702, a subscalar computing unit 704 and a post-processing unit 706. The preprocessing unit 702 may receive input operands as atomic datum through a data input module 706. The pre-processing module may include a data fragment module 708, a process scheduling module 710.

The data input module 706 may receive data input in form of at least two or more atomic data of pre-defined size as input operands. In an embodiment, the size of the input data may range from 1 bit to n-bits, where n may be an even number. The data fragmentation module 708 may split the each of the input datum into sub-atomic fragments based on a pre-defined valency. Further, the process scheduling module 710 may split each of plurality of atomic operations into a plurality of sub-atomic operations. In an embodiment, each of the atomic operations may be split into a corresponding plurality of sub-atomic operations based on the complexity of the operation and time taken to complete each of the plurality of sub-atomic operations. In an exemplary implementation depicted in FIG. 6A, FIG. 6B and FIG. 6C may be performed using only one instance of the unit, all three atomic operations 602-606 may be computed in a subscalar computing manner. The valency may be pre-defined based on a minimum bitsize of sub-atomic data fragments which may be processed in a single sub-atomic operation. In an embodiment, the valency may be equal to, but not limited to, 1 bit, 2 bit, 4 bit, 8 bit, 16 bit, 32 bit, and so on.

The process scheduling module 710 may pipeline the subatomic operations in a manner that the subatomic data fragments or a carry_in and one more subatomic result or a carry_out of the subatomic operations performed by the subscalar computing unit 704 are propagated in a pipelined subscalar manner. In an embodiment, the subatomic operations in the subscalar computing unit 704 may be pipelined in a manner to generate a staircase shaped data wavefront for integer type of operands. In an embodiment, the data wavefront may be defined based on a temporal shape of consumption and production of subatomic input data fragments and subatomic output data fragments by the pipelined subatomic operations. In an embodiment, the data wavefront may of different step shape for data types like floating points, posits, or any other compound data types.

In an embodiment, the subscalar computing unit 704 may include a plurality of partial processing units 712a-n. The computational logic implemented by the subscalar computing unit 704 may have a same shape of the data wavefront for all the input operands consumed and all the output produced by every partial processing unit 712. In an embodiment, the data wavefront may be preserved throughout any given partial processing unit 712.

The post processing unit 706 may include a data defragmentation module 714 and a reverse differential module 716. In an embodiment, when the partial processing unit's 712 boundaries are crossed, the wavefront may be reshaped by inserting suitable synchronizing registers by the data defragmentation module 714. The data defragmentation module 714 defragments the subatomic output data degenerated in order to generate atomic output data. In an embodiment, the partial processing unit 712 may be implemented using one or more of combinational circuits. Further, for example, the partial processing unit 712 may take the form of a logic primitive or a micro-cell as will be described in greater detail herein below.

The reverse differential module 716 may determine a clock cycle for the computation of each of the subatomic operations based on the types of atomic operations required to be performed in a computation logic implementation. The process scheduling module 710 may implement required latency to delay output of the subatomic operations in order synchronize the output of one subatomic operation to be input to a subsequent subatomic operation in order to implement a subscalar computational methodology. The data output module 712 may output the atomic and subatomic data computed by each of the atomic or subatomic operations respectively, using the subscalar computational logic.

FIG. 8 illustrates a flowchart of performing data dependent operations, in accordance with an embodiment of the present of disclosure. At step 802, at least two inputs as atomic datum may be received. In an embodiment, the atomic datum may be of a pre-defined bit size. At step 804, the atomic datum may be split into a plurality of sub-atomic data fragments based on a pre-defined valency. At step 806, each of a plurality of atomic operations may be split into a plurality of sub-atomic operations based on a complexity of the plurality of atomic operations. At step 808, at least one sub-atomic operation may be performed on at least two sub-atomic data fragments from the plurality of sub-atomic data fragments to generate at least one sub-atomic output data. In an embodiment, the at least one sub-atomic operation may be performed by processing the at least two sub-atomic data fragments to produce the at least one sub-atomic output data in different clock cycles and in a time-multiplexed manner.

It may be noted, the computational logic may be implemented using electronic design and automation (EDA) tools and silicon foundries provide optimized pre-defined layouts using standard logic gates having various fan-ins and fan-outs, which are known as “standard cells” and pre-designed self-contained logic modules known as macro cells. The macro cells may include commonly used data-path elements for example PLLs, ALUs, adders, multipliers, multiplexers, processors, and the like. In an exemplary embodiment, the components employed may include, but not limited to padd as depicted in FIG. 2A. In the instant disclosure, the computational logic using subscalar methodology may be implemented using custom logic blocks which may be better suited in VLSI automated design flows. In the instant disclosure such custom logic blocks may be termed as micro-cells. Such micro-cells may be connected in various combinations and topologies to create useful arithmetic and logic modules which may include but not limited to adders, subtractors, shifters, multiplexers, demultiplexers, comparators, and the like, from which complete data-paths may be synthesized.

Accordingly, subscalar computation units may operate on sub-atomic data and produce partial results or subatomic output data, so provisions for one more operand (carry_in) and one more result (carry_out) must be provided. In an embodiment, the outputs may be latched in output registers so that they may be used in synchronous manner in subsequent cycles. The valency of all the operands and all the results are kept constant throughout which, in general, may be a bit, pair (2-bit), nibble (4-bit), byte (8-bit), or even half-word (16-bit).

In an embodiment, Table 3 below provides the details of functional semantics and implementation logics used for an exemplary collection of logic primitives having a valency of 2-bits. The logic primitives are chosen such that the collection is complete (any logic can be realized) and efficient (dedicated logic primitives for commonly used data-path elements) but by no means exhaustive. It may be noted that all the logic primitives in the table have 3 inputs and 2 outputs, which may not necessarily be all connected. Such regularity helps in better VLSI layouts and placement or routing as well as provides a means for creating prefabricated raw chips such as sea of gates, FPGAs, PLDs, and the like. For other valencies like a nibble, byte, half-word, etc. the implementation logic can be easily derived.

TABLE 3

| Subscalar | | | |
|---|---|---|---|
| Logic | | | |
| Primitive | Connections | Functional Semantics | Implementation Logic |
| logic | c = func | if (func_{1..0} = 0) | x₀ = b₁c₁ c₀′ + a₀b₀c₁′c₀ |
| | b = data_in_0 | data_out_{1..0} = (data_in_0)′_{1..0} | + b₀′c₁′c₀′ |
| | a = data_in_1 | elseif (func_{1..0} = 1) | + a₀′b₀c₁ |
| | x = data_out | data_out_{1.}_{^{.0}} | + a₀b₀′c₁ |
| | y = func | = (data_in_1 & data_in_0)_{1..0} | x₁ = b₁c₁ |
| | | elseif (func_{1.}_{^{.0}} = | c₀′ + a₁b₁c₁′c₀ |
| | | data_out_{1.}_{^{.0}} (data_in_1 | + b₁′c₁′c₀′ |
| | | \|\| data_in_0)_{1..0} | + a₁′b₁c₁ |
| | | elseif (func_{1.}_{^{.0}} = | + a₁b₁′c₁ |
| | | data_out_{1.}_{^{.0}} | y₀ = c₀ |
| | | =(data_in_ ⊕ data_in_0)_{1.}_{^{.0}} | y₁ = c₁ |
| shift | b = data_in | data_out_0_{1..0} ^{:} (data_in_{1.}^{.0} | x |
| | c = shamt | << shamt)_{1..0} | ₁ = a₀b₀y |
| | x = data_out₀ | data_out_1_{1..0} ^{:} (data_in_{1.}_{^{.0}} | ₁ = a₁b₀ |
| | y = data_out₁ | << shamt)_{3..2} | |
| mask | c = func | if (func_{1.}_{^{.0}} = 1 | x c₀ + b₀c₁′c₀ |
| | b = data_in | dataₒᵤₜ = data_in₀, data_in₀ | x c₀ + b₀c₁′c₀ |
| | x = data_out | elseif (func_{1.} [symbol] = 2) | |
| | | dataₒᵤₜ = data_in₁ , data_in₁ | |
| padd | c = carry_in | sum_{1.}_{^{.0}} =(addend_{1.}_{^{.0}} + augend_{1..0} | x₀ = a₀b₀′c₀′ + a₀′b₀c₀′ |
| | b = augend | + carry_in₀)_{1..0} | + a₀′b₀′c₀ |
| | a = addend | carry_out₀ =(addend_{1..0} | x₁ |
| | x = sum | + augend_{1..0} | = a₁b₁′b₀′c₀′ + a₁′b₁b₀′c₀′ |
| | y = carry_out | + carry_in₀)₂ | + a₁a₀′b₁′c₀′ + a₁′a₀′b₁c₀′ |
| | | | + a₁a₀′b₁′b₀′ + a₁′a₀′b₁b₀′ |
| | | | + a₁′b₁′b₀c₀ + a₁′a₀b₁′c₀ + |
| | | | a₁′a₀b₁′b₀ |
| | | | y₀ = b₁b₀c₀ + a₁b₀c₀ |
| | | | + a₀b₁c₀ |
| | | | + a₁a₀c₀ |
| | | | + a₀b₁b₀ |
| | | | + a₁a₀b₁ |
| | | | + a₁b₁ |
| psub | c = borrow_in | difference_{1..0} = (minuend_{1..0} + | x₀ = a₀b₀′c₀′ + a₀′b₀c₀′ |
| | b = subtrahend | subtrahend_{1..0} | + a₀′b₀′c₀ |
| | a = minuend | + borrow_in₀)_{1..0} | + a₀b₀c₀ |
| | x = difference | borrow_out₀ = (minuend_{1..0} | x₁ |
| | y = borrow_out | + subtrahend_{1..0} | = a₁b₁′b₀′c₀′ + a₁a₀b₁′c₀′ |
| | | + borrow_in₀)₂ | + a₁a₀b₁′b₀′ + a₁′b₁′b₀′c₀′ |
| | | | + a₁′a₀b₁c₀′ + a₁′a₀b₁b₀′ |
| | | | + a₁′b₁′b₀c₀ + a₁b₁b₀c₀ |
| | | | + a₁′a₀′b₁′c₀ + a₁a₀′b₁c₀ |
| | | | + a₁′a₀′b₁′b₀ + a₁a₀′b₁b₀ |
| | | | y₀ |
| | | | = a₁′b₁′b₀c₀ + a₁b₁b₀c₀ |
| | | | + a₁′a₀′b₁′c₀ + a₁a₀′b₁c₀ |
| | | | + a₁′a₀′b₁′b₀ + a₁a₀′b₁b₀ |
| | | | + a₀′b₁ |
| pmlt | c = augend | product_low_{1..0} = (multiplicand_{1..0} | x₀ = a₀b₀c₀′ + b₀′c₀ + a₀′c₀ |
| | b = multiplier | × multiplier_{1..0} | x₁ |
| | a = multiplicand | + augend₀)_{1..0} | = a₁′a₀b₁′b₀c₁′c₀ |
| | x = product_low | product_high_{1..0} | + a₁a₀b₁′c₁c₀ + a₀′b₁b₀c₁c₀ |
| | y = product_high | = (multiplicand_{1..0} | + a₁a₀b₁b₀c₁c₀′ |
| | | × multiplier_{1..0} | + a₁′a₀b₁c₁′c₀′ |
| | | + augend₀)_{3..2} | + a₁b₁′b₀c₁′c₀′ |
| | | | + a₁a₀′b₁b₀′c₁ + a₁′b₁′c₁c₀′ |
| | | | + a₁b₁b₀c₁′c₀ + a₀b₁b₀c₁′c₀′ |
| | | | + a₁a₀′b₀c₁′ + b₁′b₀′c₁ + |
| | | | a₁′a₀′c₁ |
| | | | y₀ |
| | | | = a₁a₀′b₁c₁′ + a₁a₀b₁′b₀c₀ |
| | | | + a₁′a₀b₁b₀c₀ + a₁a₀′b₁b₀′c₁ |
| | | | + a₁b₁b₀′c₁′ + a₁′a₀b₁c₁ |
| | | | + a₁b₁′b₀c₁ + a₀b₀c₁c₀ |
| | | | y₁ = a₁a₀b₁c₁ + a₁b₁b₀c₀ |
| | | | + a₁a₀b₁b₀ |
| comp | c = comp_so_far | if (data_in_0 | y₀ = a₁′b₁c₀′ + a₁′a₀′b₀c₀′ |
| | b = data_in_0 | = data_in_1 & comp_so_far = 00) | + a₀′b₁b₀c₀′ |
| | a = data_in_1 | data_out_{1.0} = 00 | + a₁′a₀′c₁′c₀ |
| | y = data_out | elseif (data_in_0 > data_in_1 | + a₀′b₁c₁′c₀ |
| | | \|\| data_in_0 | + a₁′b₁c₁′ |
| | | = data_in_1 & comp_so_far = 01) | + a₁′b₀c₀′c₁ |
| | | data_out_{1.0} = 01 | + b₁b₀c₁′c₀ |
| | | elseif (data_in_0 < data_in_1 | y₁ |
| | | \|\| data_in_0 | = b₁′b₀c₁c₀ + a₁b₀′c₁c₀′ |
| | | = data_in_1 & comp_so_far = 10) | + a₁b₁′c₀′ + a₀b₁′c₁c₀′ |
| | | data_out_{1..0} = 10 | + a₁a₀c₁c_{′0} + a₁b₁′c₁′ |
| | | | + a₀b₁′b₀′c₁′c₀′ |
| | | | + a₁a₀b₁′b₀c₁′ |
| mux | c = select | if (select = 00) | x₀ |
| | b = data_in_0 | data_out = data_in_0 | = a₀b₁′b₀c₁′c₀′ |
| | a = data_in_1 | elseif (select = 11) | + a₁′b₁b₀c₁′c₀′ + a₀c₁c₀ |
| | y = data_out | data_out = data_in_1 | + a₁′b₀c₁′c₀′ |
| | | | x₁ = a₁a₀′b₀c₁′c₀′ + a₁c₁c₀ |
| | | | + b₁c₁′c₀′ |
| | | | y₀ = c₀ |
| | | | y₁ = c₁ |
| demux | c = select | if (select = 00) | x₀ = b₀c₁′c₀′ |
| | b = data_in | data_out_0 = data_in elseif | x₁ = b₁c₁′c₀′ |
| | x = data_out_0 | (select = 11) | y₀ = b₀c₁c₀ |
| | y = data_out_1 | data_out_1 = data_in | y₁ = b₁c₁c₀ |

[symbol]

indicates data missing or illegible when filed

The Table 4 indicates the area-latency characterization of the proposed logic primitives at various valencies as implemented in CMOS using sky130_fd_sc_hd standard cell library with an “open source” digital ASIC implementation flow “Open Lane”.

TABLE 4
Subscalar

| Logic | Area (μm²) | | | Latency (n sec) | | |
|---|---|---|---|---|---|---|
| Primitive | 2-bit | 4-bit | 8-bit | 2-bit | 4-bit | 8-bit |
| logic | 330 | 430 | 630 | 30 | 30 | 30 |
| shift | 330 | 430 | 630 | 30 | 30 | 30 |
| mask | 330 | 430 | 630 | 30 | 30 | 30 |
| padd | 450 | 920 | 12,680 | 30 | 50 | 60 |
| psub | 450 | 920 | 12,680 | 30 | 50 | 60 |
| pmlt | 1,180 | 5,620 | 24,320 | 60 | 120 | 220 |
| comp | 80 | 160 | 320 | 90 | 150 | 250 |
| mux | 180 | 340 | 660 | 20 | 20 | 20 |
| demux | 180 | 340 | 660 | 20 | 20 | 20 |

In a preferred embodiment, several benchmark logic circuits may be synthesized as unpipelined, pipelined-pair, pipelined-nibble, pipelined-byte, Subscalar-pair, Subscalar-nibble and Subscalar-byte implementations using open-source digital ASIC implementation flow Open Lane using sky130_fd_sc_hd standard cell library. The respective execution times and chip areas are highlighted in Table 5.

TABLE 5

| Benchmark | | Execution Time (m sec) | | | Area (mm²) | | |
|---|---|---|---|---|---|---|---|
| Circuits | Implementation | 8-bit | 16-bit | 32-bit | 8-bit | 16-bit | 32-bit |
| diffeq | Unpipelined | 0.30580 | 1.33440 | 2.66880 | 0.22212 | 0.78208 | 2.89464 |
| | Pipelined-pair | 0.39198 | 0.62550 | 1.05918 | 0.17972 | 0.64856 | 2.15840 |
| | Pipelined-nibble | 0.68944 | 0.78396 | 1.25100 | 0.19016 | 0.63720 | 2.05552 |
| | Pipelined-byte | 0.30580 | 1.03416 | 1.43726 | 0.25597 | 0.69402 | 2.42960 |
| | Subscalar-pair | 0.15846 | 0.19182 | 0.26412 | 0.11353 | 0.40647 | 1.54003 |
| | Subscalar-nibble | 0.24696 | 0.31692 | 0.38364 | 0.13904 | 0.45476 | 1.63556 |
| | Subscalar-byte | 0.30580 | 0.45276 | 0.58102 | 0.20151 | 0.57326 | 1.89405 |
| ellipf | Unpipelined | 0.00924 | 0.01078 | 0.01232 | 0.09594 | 0.22698 | 0.52650 |
| | Pipelined-pair | 0.01584 | 0.01848 | 0.02112 | 0.08788 | 0.35828 | 0.48724 |
| | Pipelined-nibble | 0.02464 | 0.03080 | 0.03696 | 0.08840 | 0.33280 | 0.48880 |
| | Pipelined-byte | 0.02792 | 0.03696 | 0.04620 | 0.11518 | 0.30706 | 0.84422 |
| | Subscalar-pair | 0.00462 | 0.00462 | 0.00462 | 0.04680 | 0.09360 | 0.18720 |
| | Subscalar-nibble | 0.00770 | 0.00770 | 0.00770 | 0.04784 | 0.09568 | 0.19136 |
| | Subscalar-byte | 0.00924 | 0.00924 | 0.00924 | 0.08242 | 0.16484 | 0.32968 |
| gcd | Unpipelined | 0.24948 | 0.29106 | 0.33264 | 0.03829 | 0.08333 | 0.18061 |
| | Pipelined-pair | 0.28980 | 0.33120 | 0.38924 | 0.03134 | 0.09778 | 0.15146 |
| | Pipelined-nibble | 0.33120 | 0.38640 | 0.44160 | 0.02874 | 0.08748 | 0.14096 |
| | Pipelined-byte | 0.24948 | 0.49680 | 0.57960 | 0.03254 | 0.07983 | 0.20391 |
| | Subscalar-pair | 0.20790 | 0.31878 | 0.58160 | 0.02344 | 0.04688 | 0.09376 |
| | Subscalar-nibble | 0.25410 | 0.34650 | 0.53130 | 0.02094 | 0.04188 | 0.08376 |
| | Subscalar-byte | 0.24948 | 0.30492 | 0.41580 | 0.02624 | 0.05248 | 0.10496 |
| Kalman | Unpipelined | 2.85696 | 3.33312 | 3.80928 | 17.34844 | 62.54508 | 235.02924 |
| | Pipelined-pair | 1.40160 | 2.61888 | 3.05536 | 13.97560 | 51.15672 | 174.61656 |
| | Pipelined-nibble | 1.52768 | 2.80320 | 4.80128 | 14.89208 | 50.42736 | 166.30016 |
| | Pipelined-byte | 2.85696 | 3.05536 | 5.13920 | 20.26164 | 55.29468 | 195.94180 |
| | Subscalar-pair | 0.53568 | 1.60704 | 2.41056 | 8.66012 | 32.18564 | 124.61332 |
| | Subscalar-nibble | 0.49104 | 1.07136 | 1.60704 | 10.82312 | 36.28544 | 132.72592 |
| | Subscalar-byte | 0.47616 | 0.98208 | 1.07136 | 15.88388 | 45.87336 | 153.68236 |
| qsort | Unpipelined | 1.95432 | 2.28004 | 2.60576 | 0.62436 | 1.31892 | 2.78292 |
| | Pipelined-pair | 1.00590 | 1.20708 | 1.40826 | 0.55060 | 1.46624 | 2.47384 |
| | Pipelined-nibble | 0.95002 | 1.30288 | 1.62860 | 0.52282 | 1.35764 | 2.36168 |
| | Pipelined-byte | 0.96566 | 1.65542 | 2.06928 | 0.56197 | 1.27734 | 3.01488 |
| | Subscalar-pair | 0.90658 | 0.92031 | 0.93405 | 0.46844 | 0.93688 | 1.87376 |
| | Subscalar-nibble | 1.51096 | 1.53385 | 1.55675 | 0.44170 | 0.88340 | 1.76680 |
| | Subscalar-byte | 1.81316 | 1.84063 | 1.86810 | 0.49645 | 0.99290 | 1.98580 |

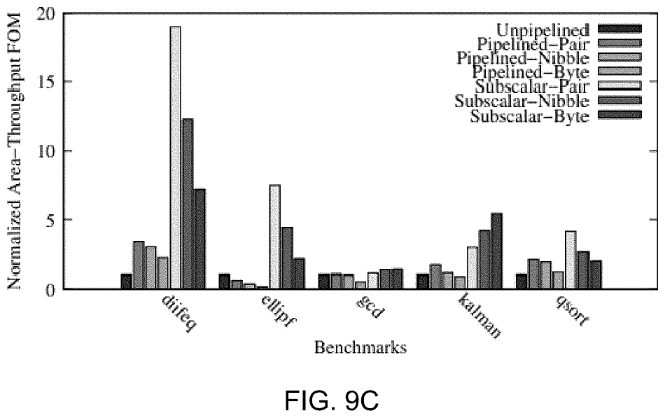

FIG. 9A, FIG. 9B and FIG. 9C illustrates area-throughput figure-of-merit (FOM) for the unpipelined, pipelined, and subscalar implementations at pair, nibble, and byte valencies of the chosen benchmark circuits are plotted as histograms for an 8-bit, 16bit, 32-bit data-path widths, in accordance with an experimental embodiment of the present disclosure. Further, details are provided in the concurrently filed Indian patent applications titled “Microcell Library For Implementation Of Computational Logic Using Digital VISI Systems” and “Data Path Elements For Implementation Of Computational Logic Using Digital VISI Systems” and the IEEE paper titled “Novel VLSI Architectures and Micro-Cell Libraries for Subscalar Computations” each incorporated herein in entirety by reference.

In an embodiment, the subscalar computations may have the following advantages including new data-path synthesis methodology of a partial processing of data at a sub-word boundary. The logic primitives for VLSI realization may be used at an intermediate level of complexity and functionality between standard gates and macro cells. All the logic primitives in the collection may have a 3-input 2-output interface which may be implemented as hardwired circuits or as lookup tables or even as coarse grain reconfigurable logic. Further, the designs of a few commonly used data-path elements may be composed of elements chosen from the proposed collection. Also, new EDA tools may be developed which may be adapted to be used in reconfigurable devices. The disclosed subscalar computation may in general be used for computing systems ranging from embedded to data centre scales.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate micro-cells or data path element may be performed by the same micro-cells or data path element. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention may not be limited only by the claims. Additionally, although a feature may appear to be described in connection with embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of implementing computational logic, comprising:
receiving, by a subscalar computing unit, at least two inputs as atomic datum, wherein the atomic datum is of a pre-defined bit size;
splitting, by the subscalar computing unit, the atomic datum into a plurality of sub-atomic data fragments based on a pre-defined valency;
splitting, each of a plurality of atomic operations into a plurality of sub-atomic operations, wherein the splitting is based on a complexity of the plurality of atomic operations; and
performing at least one sub-atomic operation on at least two sub-atomic data fragments from the plurality of sub-atomic data fragments to generate at least one sub-atomic output data,
wherein the at least one sub-atomic operation is performed by processing the at least two sub-atomic data fragments to produce the at least one sub-atomic output data in different clock cycles and in a time-multiplexed manner.

2. The method as claimed in claim 1, wherein duration of the clock-cycles is determined based on a processing time of each of the plurality of sub-atomic operations.

3. The method as claimed in claim 1, wherein the at least one sub-atomic output data produced due to processing of the sub-atomic data fragments in each of the sub-atomic operations have a temporal data wave front based on a data type of the atomic operation.

4. The method as claimed in claim 1, wherein the pre-defined valency is selected from the group consisting of 1-bit, 2-bits, a nibble (4-bits), a byte (8-bits), and a half-word (16-bits) or any other integer power of 2.

5. The method as claimed in claim 2, wherein the valency of each of the plurality of sub-atomic data fragments and the sub-atomic output data is same.

6. The method as claimed in claim 1, wherein the sub-atomic output of a preceding sub-atomic operation from the plurality of sub-atomic operations is input as the sub-atomic data fragment to a subsequent sub-atomic operation from the plurality of sub-atomic operations in a synchronized manner such that the sub-atomic data fragments follow a lock-step data wave front shape.

7. The method as claimed in claim 1, comprises performing a first set of sub-atomic operations of a first atomic operation from the plurality of atomic operations followed by a second set of sub-atomic operations of the first atomic operation in a time multiplexed manner.

8. The method as claimed in claim 1, wherein the first set of sub-atomic operation of the first atomic operation is followed by performing a first set of sub-atomic operation of a second atomic operation from the plurality of atomic operations in a pipelined manner such that a sub-atomic output data of the first set of sub-atomic operations of the second atomic operation is fed as feedback input to the first set of sub-atomic operations of the first atomic operation and a sub-atomic output of the second set of sub-atomic operations of the second atomic operation is fed as feedback input to the second set of sub-atomic operations of the first atomic operation.

9. The method as claimed in claim 1, wherein the sub-atomic operations comprise one of bit-wise logic, bi-directional shift, partial add, partial subtract, partial multiply-add, predication, multiplexing, de-multiplexing etc.

10. The method as claimed in claim 1, wherein in case data types of the sub-atomic output data and the sub-atomic data fragments are not uniform, the data wavefront is reshaped by inserting necessary wave shaping registers.

11. A system for implementing computational logic in digital VLSI systems comprising:
one or more logic circuitry configured to:
receive at least two inputs as atomic datum, wherein the atomic datum is of a pre-defined bit size;
split the atomic datum into a plurality of sub-atomic data fragments based on a pre-defined valency;
split each of a plurality of atomic operations into a plurality of sub-atomic operations, wherein the splitting is based on a complexity of the plurality of atomic operations; and
perform at least one sub-atomic operation on at least two sub-atomic data fragments from the plurality of sub-atomic data fragments to generate at least one sub-atomic output data,
wherein the at least one sub-atomic operation is performed by processing the at least two sub-atomic data fragments to produce the at least one sub-atomic output data in different clock cycles and in a time-multiplexed manner.
